(19) United States
(12) Patent Application Publication
(10) Pub. No.: US 2015/0224978 A1
(43) Pub. Date: Aug. 13, 2015

(54) BRAKING/DRIVING FORCE CONTROL DEVICE

(71) Applicant: Satoshi Shimizu, Susono-shi (JP)

(72) Inventor: Satoshi Shimizu, Susono-shi (JP)

(73) Assignee: TOYOTA JIDOSHA KABUSHIKI KAISHA, Toyota-shi, Aichi (JP)

(21) Appl. No.: 14/416,933

(22) PCT Filed: Jul. 26, 2012
(86) PCT No.: PCT/JP2012/069025

§ 371 Date: Jan. 23, 2015

(51) Int. Cl. B60W 10/184; B60T 8/171; B60T 8/58; B60W 40/13; B60T 8/175; B60W 10/08; B60W 40/076; B60W 40/105; B60T 8/172; B60T 8/1761

(52) U.S. Cl. CPC B60W 10/184; B60T 8/172; B60T 8/171; B60T 8/58; B60T 8/1761; B60T 8/175; B60W 10/08; B60W 40/076; B60W 40/105; B60W 40/13; B60W 2520/10; B60W 2520/26; B60W 2520/28; B60W 2550/12; B60W 2550/142; B60W 2550/148

(57) ABSTRACT

A braking/driving force control device includes a braking/driving force control unit configured to control a braking/driving force of a vehicle based on a wheel speed; and wheel speed correcting unit configured to compute a wheel speed correction amount for matching detected speeds of all wheels to a predetermined speed for every wheel and corrects the detected wheel speed of the wheel with the wheel speed correction amount of the wheel, or compute a wheel diameter correction amount for matching detected wheel diameters of all wheels to a predetermined wheel diameter for every wheel and corrects the detected wheel speed of the wheel using the wheel diameter correction amount of the wheel, wherein the wheel speed correcting unit computes a correction value of the wheel speed correction amount or a correction value of the wheel diameter correction amount.

### FIELD

The present invention relates to a braking/driving force control device that performs a control of a braking/driving force of a vehicle.

### BACKGROUND

Conventionally, for this type of braking/driving force control device, a braking/driving force control device that controls a braking/driving force of a control target wheel according to a state of a vehicle such as a vehicle behavior is known. For example, when performing a vehicle control such as an EBD control, an ABS control, a TRC control, the braking/driving force control device adjusts the braking force and the driving force of the control target wheel while monitoring a wheel speed detected with a wheel speed sensor, a vehicle body speed estimated based on the wheel speed, a slip ratio of a wheel, and the like. All of the wheels of the vehicle may not necessarily hold a difference of an even wheel diameter (wheel radius or wheel diameter) at the time of factory shipment due to wear, and the like. At the wheel where the wheel diameter varied due to wear, and the like, the detected wheel speed may possibly shift with respect to the actual wheel speed (hereinafter referred to as “actual wheel speed”). Furthermore, when the wheel diameter of each wheel differs due to the variation of the wheel diameter, and the like, the detection error of the wheel speed may lead to error in the vehicle body speed and a computation value of the slip ratio, and hence a highly accurate braking/driving force control may not be performed.

A technique of correcting the wheel speed has been proposed in the conventional art. As a technique of correcting the wheel speed, a technique of computing a predetermined correction value for every wheel while the vehicle is performing a steady travelling (straight travelling at constant speed), and factoring in the correction value for the wheel to the detected wheel speed through multiplication, addition, and the like to correct the wheel speed of each wheel is known. For example, a wheel speed correction device of patent literature 1 corrects a coefficient including the wheel radius for every wheel, and uses the corrected coefficient to correct to the wheel speed that takes into consideration the variation in the wheel diameter involved in wear and turning operation. A method and device for correcting a wheel speed of patent literature 2 computes a ratio of a value corresponding to a moving distance of each wheel and a value corresponding to a moving distance of at least one other wheel as a correction coefficient, and corrects the wheel speed of each wheel with the correction coefficient while the vehicle is in a straight state.

### CITATION LIST

### Patent Literature

Patent Literature 1: Japanese Patent Application Laid-open No. 4-283665

Patent Literature 2: Japanese Patent Application Laid-open No. 10-67313

### SUMMARY

### Technical Problem

A ground load of each wheel changes with increase/reduction in a carrying capacity of a baggage. When the ground load of the drive wheel is small, a slip ratio of a drive wheel may possibly become higher than a slip ratio of a driven wheel, and the drive wheel may also show a lock tendency with respect to the driven wheel depending on a travelling situation. Under such travelling situation, even if the correction of the wheel speed such as the computation of the correction value is executed, the accuracy of the correction is low and the braking/driving force may not be performed with high accuracy.

It is a purpose of the present invention to overcome the drawbacks of the conventional art example, and provide a braking/driving force control device capable of performing the braking/driving force control with high accuracy.

### Solution to Problem

In order to achieve the above mentioned object, a braking/driving force control device according to the present invention includes a braking/driving force control unit configured to control a braking/driving force of a vehicle based on a wheel speed; and a wheel speed correcting unit configured to compute a wheel speed correction amount for matching detected speeds of all wheels to a predetermined speed for every wheel and correct the detected wheel speed of the wheel with the wheel speed correction amount of the wheel, or compute a wheel diameter correction amount for matching detected wheel diameters of all wheels to a predetermined wheel diameter for every wheel and correct the detected wheel speed of the wheel using the wheel diameter correction amount of the wheel, wherein the wheel speed correcting unit computes a correction value of the wheel speed correction amount or a correction value of the wheel diameter correction amount based on a difference between an estimated vehicle body acceleration/deceleration estimated from a vehicle body speed and a detected vehicle body acceleration/deceleration detected by a vehicle body front-back acceleration sensor or an output value of a power source, and corrects the computed wheel speed correction amount with the correction value of the wheel speed correction amount or corrects the computed wheel diameter correction amount with the correction value of the wheel diameter correction amount.

Here, it is desirable that the wheel speed correcting unit executes the correction of the computed wheel speed correction amount or the correction of the computed wheel diameter correction amount while travelling on an up slope road or a down slope road.

Further, it is desirable that the wheel speed correcting unit computes a correction value of a wheel speed correction amount or a correction value of a wheel diameter correction amount based on a vehicle body speed, and corrects the wheel speed correction amount of after the correction with the correction value of the wheel speed correction amount corresponding to the vehicle body speed, or corrects the wheel diameter correction amount of after the correction with the correction value of the wheel diameter correction amount corresponding to the vehicle body speed.

Further, it is desirable that the wheel speed correcting unit computes a correction value of a wheel speed correction amount and a correction value of a wheel diameter correction amount based on a wind speed, and corrects the wheel speed correction amount of after the correction with the correction value of the wheel speed correction amount corresponding to the wind speed, or corrects the wheel diameter correction amount of after the correction with the correction value of the wheel diameter correction amount corresponding to the wind speed.

Further, it is desirable that the wheel speed correcting unit computes a correction value of a wheel speed correction amount and a correction value of a wheel diameter correction amount based on an outside temperature, and corrects the wheel speed correction amount of after the correction with the correction value of the wheel speed correction amount corresponding to the outside temperature, or corrects the wheel diameter correction amount of after the correction with the correction value of the wheel diameter correction amount corresponding to the outside temperature.

### Advantageous Effects of Invention

In the braking/driving force control device according to the present invention, the shift of the wheel speed correction amount or the wheel diameter correction amount can be corrected, and thus the correction accuracy of the correction control of the wheel speed or the wheel diameter using the wheel speed correction amount or the wheel diameter correction amount can be enhanced and the detection accuracy of the detected wheel speed can be enhanced. Therefore, the braking/driving force control device can prevent the setting of the request braking force or the request driving force based on the erroneous wheel speed, and can perform a highly accurate braking/driving force control. Furthermore, the braking/driving force control device can also perform a highly accurate braking/driving force control in the vehicle control, and avoid the intervention of an unnecessary vehicle control, intervention of an excessive vehicle control, and the like, whereby the accuracy of the vehicle control can be enhanced.

### BRIEF DESCRIPTION OF DRAWINGS

FIG. 1 is a block diagram illustrating a configuration of a braking/driving force control device according to the present invention.

FIG. 2 is a view describing a ratio of a vehicle weight and a ground load of a drive wheel.

FIG. 3 is a view describing a relationship of a slip ratio corresponding to the ground load of the drive wheel and a driving force.

FIG. 4 is a view describing force acting on a vehicle travelling on an up slope road.

FIG. 5 is a flowchart describing one example of an operation of the braking/driving force control device according to an embodiment.

FIG. 6 is a view illustrating one example of a correction value with respect to a correction amount according to the embodiment.

FIG. 7 is a flowchart describing one example of an operation of the braking/driving force control device according to a first modification.

FIG. 8 is a view illustrating one example of a correction value with respect to a correction amount according to the first modification.

FIG. 9 is a view illustrating one example of a correction value with respect to a correction amount according to a second modification.

FIG. 10 is a flowchart describing one example of an operation of a braking/driving force control device according to the second modification.

FIG. 11 is a view illustrating one example of a correction value with respect to a correction amount according to a third modification.

FIG. 12 is a flowchart describing one example of an operation of a braking/driving force control device according to the third modification.

FIG. 13 is a view illustrating one example of a correction value with respect to a correction amount according to a fourth modification.

FIG. 14 is a flowchart describing one example of an operation of a braking/driving force control device according to the fourth modification.

### DESCRIPTION OF EMBODIMENTS

An embodiment of a braking/driving force control device according to the present invention will be hereinafter described in detail based on the drawings. The present invention is not limited by such embodiment.

### Embodiment

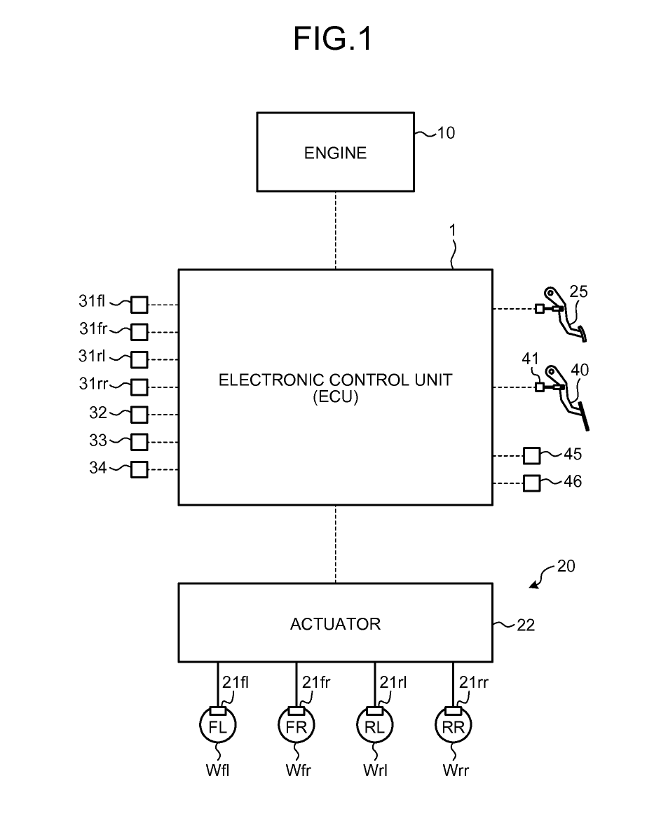

An embodiment of the braking/driving force control device according to the present invention will be described based on FIGS. 1 to 14.

The braking/driving force control device of the present embodiment controls a driving force output by a power source 10 and a braking force output by a braking device 20, where a computation processing function thereof is prepared as one function of an electronic control unit (ECU) 1.

The power source 10 is an engine, a rotating electrical machine, and the like, and generates a driving force in vehicle travelling. The driving force is controlled by a braking/driving force control unit of the electronic control unit 1, and is transmitted to a drive wheel through a power transmitting device (not illustrated) such as a transmission. The engine is a so-called engine such as an internal combustion engine, an external combustion engine. The rotating electrical machine is an electrical motor, an electrical power generator, and the like. The vehicle is mounted with at least one of the engine and the rotating electrical machine for the power source 10.

The braking device 20 supplies a brake fluid pressure to a braking force generating unit (caliper or the like) 21fi, 21ri (i=l, r) for each wheel Wfi, Wri (i=l, r), and causes each wheel Wfi, Wri to generate the braking force corresponding to the brake fluid pressure. Here, Wfi represents the front left wheel Wfl and the front right wheel Wfr. Wri represents the rear left wheel Wrl and the rear right wheel Wrr. Furthermore, 21fi represents a braking force generating unit 21fl of the front left wheel Wfl and a braking force generating unit 21fr of the front right wheel Wfr. Reference sign 21ri represents a braking force generating unit 21rl of the rear left wheel Wrl and a braking force generating unit 21rr of the rear right wheel Wrr.

The braking device 20 includes an actuator 22 serving as a brake fluid pressure adjustment unit for controlling the braking force for each wheel Wfi, Wri. The actuator 22 is controlled by the braking/driving force control unit of the electronic control unit 1, and can supply the brake fluid pressure corresponding to an operation amount (pedal stroke, pedal depression force, or the like) of a brake pedal 25 by a driver as is or after adjustment to the braking force generating units 21fi, 21ri. The actuator 22 can also apply the braking force only to a specific wheel (control target wheel) among the respective wheels Wfi, Wri.

The braking/driving force control device controls the braking/driving force of the control target wheel when performing the vehicle control such as the EBD control, the ABS control, the TRC control, the VSC control.

The Electronic Brake force Distribution (EBD) control is a control that monitors the wheel speed of each wheel Wfi, Wri and causes each wheel Wfi, Wri to generate a braking force at an appropriate target braking force distribution of each wheel Wfi, Wri corresponding to the travelling situation. For example, in the brake operation on a flat road or a down slope road, the braking force is controlled at the target braking force distribution at which all the wheels Wfi, Wri have an equal slip ratio so that the slip ratio of the rear wheel Wri does not become higher than that of the front wheel Wfi.

The respective wheel speed is detected with a wheel rotation angle sensor 31fi, 31ri (i=l, r) serving as a wheel speed detecting device arranged for every wheel Wfi, Wri. Here, 31fi represents a wheel rotation angle sensor 31fl of the front left wheel Wfl, and a wheel rotation angle sensor 31fr of the front right wheel Wfr. Reference sign 31ri represents a wheel rotation angle sensor 31rl of the front left wheel Wrl, and a wheel rotation angle sensor 31rr of the front right wheel Wrr. The wheel rotation angle sensor 31fi, 31ri, for example, detects the rotation angle of the respective axle of each wheel Wfi, Wri. The electronic control unit 1 receives the detection signals of the wheel rotation angle sensors 31fi, 31ri, and computes the wheel speed based on the detection signals. For example, the electronic control unit 1 obtains the rotation angle speed of the axle from the detection signal, and converts the rotation angle speed by a conversion value corresponding to the wheel radius, as described above to compute the wheel speed for every wheel Wfi, Wri. The electronic control unit 1 can also compute the wheel acceleration/deceleration (differential value of the wheel speed), the vehicle body speed (vehicle speed), and the travelling distance based on the detection signal.

The Anti-lock Brake System (ABS) control is a control that prevents the lock of the control target wheel by increasing/reducing the braking force of the control target wheel during the vehicle brake by the brake operation of the driver, and monitors the wheel speed of each wheel Wfi, Wri and adjusts the braking force of the control target wheel that shows the lock tendency.

The Traction Control (TRC) control is a control that prevents idle running of the drive wheel by reducing the driving force of the power source 10 at the start of the vehicle and at the acceleration of the vehicle, and adjusts the driving force based on the wheel speed of the control target wheel, the vehicle body speed (vehicle speed), and the like.

The vehicle body speed is detected by a vehicle speed detecting device 32. For the vehicle speed detecting device 32, a rotation angle sensor that detects the rotation angle of the output shaft of the power transmitting device (e.g., transmission), a Global Positioning System (GPS) that can know the moving distance of the own vehicle position, and the like can be used. In the illustration, the wheel rotation angle sensors 31fi, 31ri are also used as the vehicle speed detecting device 32. The electronic control unit 1, for example, obtains an average value of the wheel speed of each of the wheels Wfi, Wri obtained based on the detection signals of the wheel rotation angle sensors 31fi, 31ri, and computes the vehicle body speed based on the average value of the wheel speeds. However, the drive wheel may slip with the generation of the driving force, thus fluctuating the wheel speed. Therefore, in the illustration, the average value of the wheel speeds of the driven wheels in which the fluctuation of the wheel speed is small is obtained, and the vehicle body speed is computed based on the average value of such wheel speeds. In this case, the vehicle body speed may be computed from the wheel speed of one driven wheel, or may be computed from the average value of the wheel speeds of all the driven wheels to enhance the accuracy. The electronic control unit 1 can also compute the vehicle body acceleration/deceleration (differential value of the vehicle body speed) and the travelling distance (integrated value of the vehicle body speed) based on the detection signal of the vehicle speed detecting device 32.

The Vehicle Stability Control (VSC) control is a vehicle stabilizing control that controls the braking force and the driving force of the control target wheel to generate a yaw moment in an under steer direction or an over steer direction in the vehicle body thus preventing the side skid of the vehicle body. In the VSC control, the wheel speed of each wheel Wfi, Wri, the vehicle body lateral acceleration, and the like are monitored to determine the control target wheel, which becomes the control target of the braking/driving force.

The vehicle body lateral acceleration is detected by a vehicle body lateral acceleration sensor 33. The detection signal of the vehicle body lateral acceleration sensor 33 is input to the electronic control unit 1.

Thus, in the vehicle control, the information on the wheel speed is required. However, each wheel Wfi, Wri may not necessarily wear evenly, and the wheel diameter (wheel radius or wheel diameter) and the grip may differ between the front wheels Wfi and the rear wheels Wri, for example. The owner of the vehicle may differ the wheel diameters between the front wheels Wfi and the rear wheels Wri.

When the wheel diameter is varied, the detected wheel speed may possibly shift with respect to the actual wheel speed. In this case, the computation value of the slip ratio may also shift due to the detection error of the wheel speed. As described above, the vehicle body speed is obtained based on the average value of the wheel speed of each of the wheels Wfi, Wri, and hence may possibly shift with respect to the actual vehicle body speed due to the variation in the wheel diameter of each wheel Wfi, Wri and the difference in the respective wheel diameter. Therefore, when the detection error occurs in the wheel speed, the request braking force and the request driving force are computed based on the wheel speed, the slip ratio, the vehicle body speed, and the like that are shifted than the actual speed, whereby the braking force and the driving force may become excessively larger or excessively smaller than actually required thus lowering the accuracy of the braking/driving force control. In this case, even if the vehicle body speed is detected with high accuracy without depending on the wheel speed, the accuracy of the braking/driving force control may possibly lower by the error in the wheel speed and the slip ratio. That is, when the detected wheel speed is shifted, the vehicle control of satisfactory accuracy may not be executed as the accuracy of the braking/driving force is lowered.

The electronic control unit 1 includes a wheel speed correcting unit that corrects the wheel speed detected by the wheel rotation angle sensor 31fi, 31ri by correcting the wheel speed or by correcting the wheel diameter detected by the wheel rotation angle sensor 31fi, 31ri. In the illustration, the wheel speed correcting unit is arranged as one function of the braking/driving force control device, but the wheel speed correcting unit may be arranged as a wheel speed correcting device.

The correction control of the wheel speed is executed by a method well-known in the technical field. For example, the wheel speed correcting unit computes a predetermined wheel speed correction amount KSfi, KSri (i=l, r) for each wheel Wfi, Wri while the vehicle is performing steady travelling. KSfi represents a wheel speed correction amount KSfl of the front left wheel Wfl, and a wheel speed correction amount KSfr of the front right wheel Wfr. Furthermore, KSri represents a wheel speed correction amount KSrl of the rear left wheel Wrl and the wheel speed correction amount KSrr of the rear right wheel Wrr.

The wheel speed correction amounts KSfi, KSri are provided, for example, to match the detected wheel speeds of all the wheels Wfi, Wri to a predetermined value. The predetermined value is, for example, an average value, and the like of the wheel speed of each of the wheels Wfi, Wri, and corresponds to the actual wheel speed. In the illustration, the wheel speed correction amounts KSfi, KSri for the wheels Wfi, Wri are factored in to the detected wheel speed by multiplication, addition and the like to correct the wheel speed of each wheel Wfi, Wri. When computing the wheel speed of a certain wheel in which the rotation angle of the axle is detected, for example, the wheel speed correcting unit corrects the wheel speed computed according to the rotation angle of the axle with the wheel speed correction amount KSfi (KSri) of the relevant wheel to correct the wheel speed of the wheel to the predetermined speed same as the wheel speeds of other wheels. Thus, the corrected wheel speed of the wheel is detected as being corrected to approach the actual wheel speed with the wheel speed correction amounts KSfi, KSri.

The correction control of the wheel diameter is executed by a method well-known in the technical field. For example, the wheel speed correcting unit computes a predetermined wheel diameter correction amount KRfi, KRri (i=l, r) for each wheel Wfi, Wri while the vehicle is performing steady travelling. KRfi represents a wheel diameter correction amount KRfl of the front left wheel Wfl, and a wheel diameter correction amount KRfr of the front right wheel Wfr. Furthermore, KRri represents a wheel diameter correction amount KRrl of the rear left wheel Wrl and the wheel diameter correction amount KRrr of the rear right wheel Wrr.

The wheel diameter correction amounts KRfi, KRri are provided, for example, to match the detected wheel diameters of all the wheels Wfi, Wri to a predetermined wheel diameter. The predetermined wheel diameter, for example, is an average value of the wheel diameter of each wheel Wfi, Wri, and the like, and corresponds to the actual wheel diameter. In the illustration, the wheel diameter correction amount KRfi, KRri of the wheel Wfi, Wri is factored into the computation parameter of the wheel speed by multiplication, addition, and the like to perform a correction control of the wheel diameter. The computation parameter of the wheel speed is a parameter for each wheel Wfi, Wri used in computing the wheel speed based on the detected rotation angle of the axle, and includes information on the wheel diameter. In the illustration, the conversion value, and the like correspond to the computation parameter of the wheel speed. The wheel speed correcting unit, for example, corrects in advance the computation parameter of the wheel speed with the wheel diameter correction amount KRfi, KRri, and computes the wheel speed of the wheel based on the computation parameter of the wheel including the information on the wheel diameter of after the correction and the rotation angle of the axle of the wheel when detecting the wheel speed of the wheel. Thus, the computed wheel speed of the wheel is detected as being corrected to approach the actual wheel speed with the wheel diameter correction amount KRfi, KRri.

In the vehicle, the baggage compartment is generally arranged on either the front or the back of the vehicle, and thus the ground load of the wheel Wfi, Wri changes between when the carrying capacity of the baggage is large or small. For example, in a vehicle of a rear wheel drive having the baggage compartment on the back part side of the vehicle, the ground load becomes smaller at the drive wheel Wri than the driven wheel Wfi as the carrying capacity of the baggage becomes smaller. That is, in such vehicle, the reduction degree of the ground load of the drive wheel Wri becomes large compared to the reduction degree of the ground load of the driven wheel Wfi when the carrying capacity of the baggage becomes small. This is significant in a transport vehicle in which the increasing/reducing width of the carrying capacity of the baggage is large as represented by a truck, and the like.

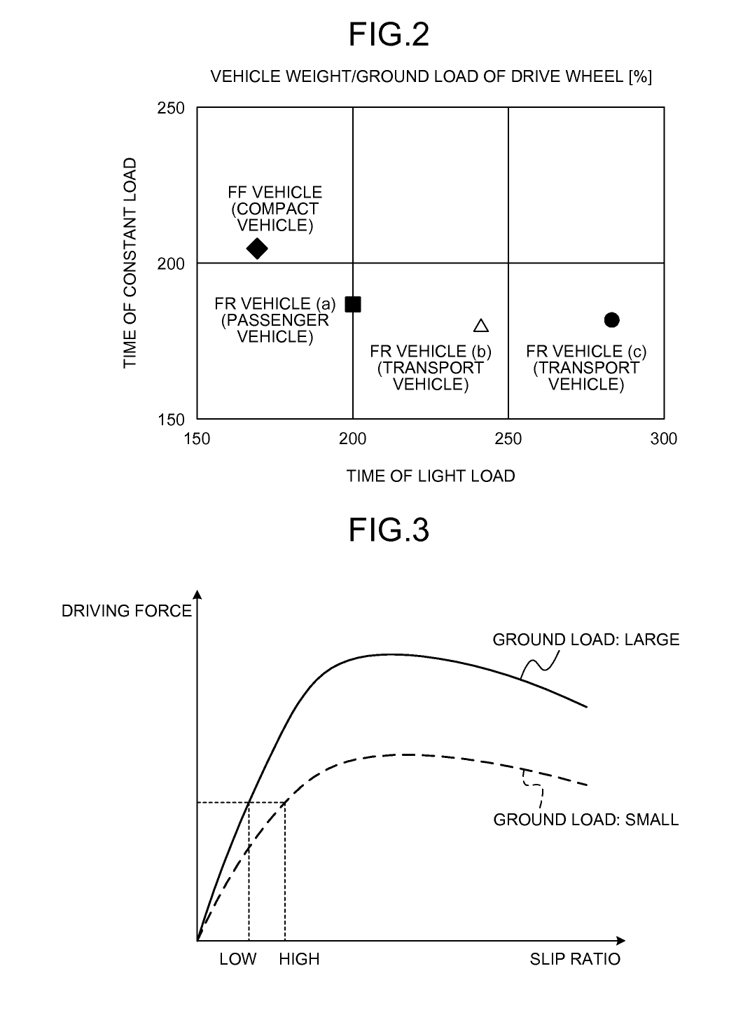

In FIG. 2, a value (hereinafter referred to as “weight ratio”) obtained by dividing the vehicle weight by the ground load of the drive wheels is illustrated in percentage. The time of light load illustrated in FIG. 2 is when the carrying capacity of the baggage is small. The time of constant load is when the baggage of a defined carrying capacity (maximum carrying capacity) is loaded. In the rear wheel drive vehicle (FR vehicle herein) including the baggage compartment on the back part side of the vehicle, the weight ratio at the time of light load tends to become larger than the weight ratio at the time of constant load. In such vehicle, the weight ratio at the time of light load becomes larger than the weight ratio at the time of constant load as the carrying capacity of the baggage becomes smaller the larger the increasing/reducing width of the carrying capacity of the baggage. The FR vehicle (a) of FIG. 2 is a typical passenger vehicle and a trunk is prepared as a baggage compartment. The FR vehicle (b) is a transport vehicle in which a loading platform or a baggage compartment is arranged on the back side of the cabin. The FR vehicle (c) is a transport vehicle in which the increasing/reducing width of the carrying capacity of the baggage is larger than the FR vehicle (b).

In FIG. 2, a vehicle (FF vehicle herein) of a front wheel drive having a baggage compartment on the back part side of the vehicle is also illustrated. The FF vehicle is a compact vehicle referred to as a so-called 2 BOX vehicle, and includes a baggage compartment on the back side of a backseat. In such vehicle, the ground load of each wheel Wfi, Wri becomes small due to the reduction of the carrying capacity of the baggage, but the reduction degree of the ground load of the driven wheel Wri close to the baggage compartment is larger than the reduction degree of the ground load of the drive wheel Wfi. In such vehicle, the weight ratio at the time of light load is smaller than the weight ratio at the time of constant load since the power source 10 is arranged on the drive wheel Wfi.

When travelling the vehicle on the flat road, the driving force that resists the forces by the road surface resistance (=coefficient of friction×ground load) and the air resistance is to be generated at the drive wheel. When travelling the vehicle on the slope road, the driving force that resists the respective forces by the road surface resistance, the air resistance, and the gravity is to be generated at the drive wheel. The load in the perpendicular direction with respect to the road surface is assumed as the ground load regardless of the presence or absence of gradient of the travelling path.

Thus, in the travelling of the vehicle, a large request driving force is necessary when the ground load is large, and only a small request driving force is necessary when the ground load is small. However, in a vehicle in which the ground load cannot be known, the computation of the request driving force corresponding to the magnitude of the ground load is difficult, and for example, assuming a ground load of a certain predetermined magnitude is acting, the request driving force is obtained by estimating the road surface resistance (friction coefficient) under that assumption. Thus, in a vehicle in which the ground load of the drive wheel is smaller than the ground load of a predetermined magnitude, the request driving force becomes excessively large and the slip ratio of such drive wheel may become high. That is, the slip ratio of the drive wheel becomes higher the smaller the ground load of the drive wheel when generating the driving force of the same magnitude (FIG. 3).

For example, in the rear wheel drive vehicle having the baggage compartment on the back part side of the vehicle, the slip ratio of the drive wheel Wri becomes high since the ground load of the drive wheel Wri becomes small by the reduction of the baggage of the baggage compartment (the weight ratio at the time of light load becomes large) when steady travelling on the flat road and the slope road. The driven wheel Wfi is not subjected to the influence of the reduction of the baggage of the baggage compartment as much as the drive wheel Wri, and thus the reduction of the ground load and the lowering of the slip ratio is small compared to the drive wheel Wri. Thus, when the baggage of the baggage compartment is reduced, the reduction degree of the ground load of the drive wheel Wri becomes greater than the reduction degree of the ground load of the driven wheel Wfi, and hence the slip ratio of the drive wheel Wri becomes higher than the slip ratio of the driven wheel Wfi the more the baggage is reduced. Therefore, as the baggage of the baggage compartment is reduced, the wheel speed of the drive wheel Wri becomes higher than the wheel speed of the driven wheel Wfi. That is, as the baggage of the baggage compartment is reduced, the respective differences of the ground load, the slip ratio, and the wheel speed becomes greater between the drive wheel Wri and the driven wheel Wfi.

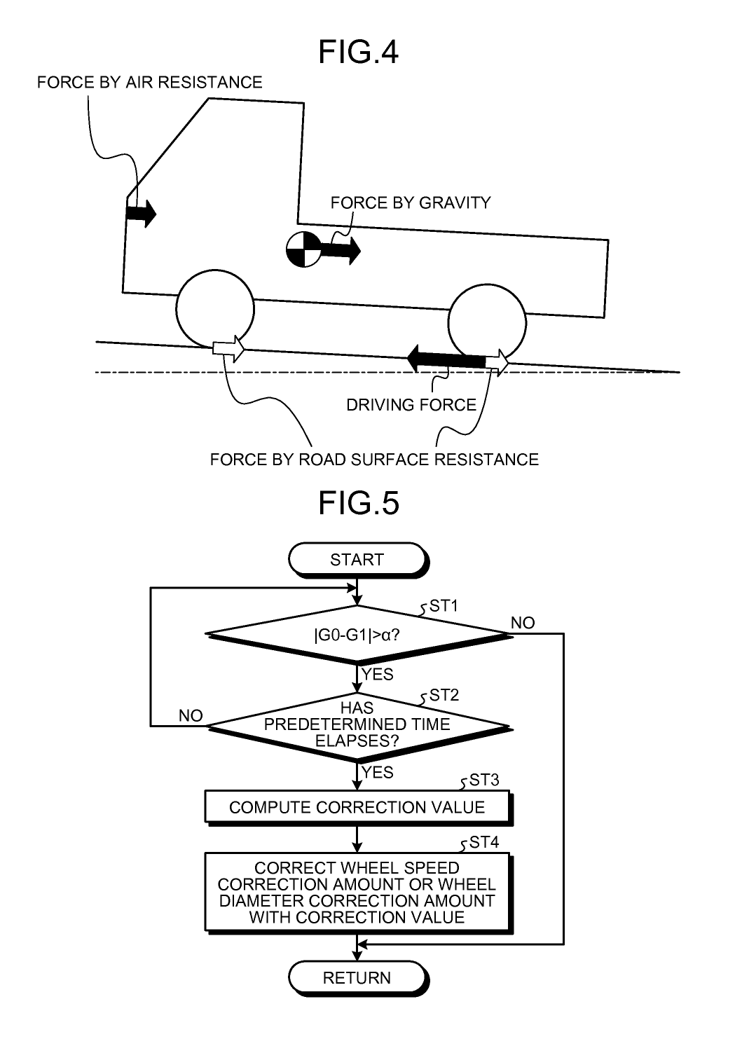

In the rear wheel drive vehicle travelling on the up slope road illustrated in FIG. 4, the slip ratio of the drive wheel Wri becomes higher than when travelling on the flat road. The vehicle may climb up the up slope road in steady travelling. Thus, in such vehicle, the computation of the wheel speed correction amount KSfi, KSri or the wheel diameter correction amount KRfi, KRri described above has a possibility of being performed while travelling on the up slope road. In such vehicle, however, the slip ratio of the drive wheel Wri may become higher than the slip ratio of the driven wheel Wfi due to the reduction of the baggage of the baggage compartment during the steady travelling on the up slope road. Therefore, the wheel speed correction amount KSri or the wheel diameter correction amount KRri of the drive wheel Wri computed under such travelling situation has a possibility of detecting the wheel speed of the drive wheel Wri detected using the same lower than the actual wheel speed. Furthermore, the wheel speed correction amount KSfi or the wheel diameter correction amount KRfi of the driven wheel Wfi computed under such travelling situation has a possibility of detecting the wheel speed of the driven wheel Wfi detected using the same higher than the actual wheel speed.

The rear wheel drive vehicle may generate the braking force at each wheel Wfi, Wri and travel down the down slope road in steady travelling. In such vehicle, the drive wheel Wri has a possibility of showing a lock tendency compared to the driven wheel Wfi under such travelling situation. The cause of generation of the braking force is at least one of the braking device 20 and the engine brake. In particular, in such vehicle, the possibility the drive wheel Wri will lock becomes high when the slip ratio of the drive wheel Wri is higher than the slip ratio of the driven wheel Wfi due to the reduction of the baggage of the baggage compartment. Therefore, the wheel speed correction amount KSri or the wheel diameter correction amount KRri of the drive wheel Wri computed under the travelling situation have a possibility of detecting the wheel speed of the drive wheel Wri detected using the same higher than the actual wheel speed. In particular, the wheel speed correction amount KSfi or the wheel diameter correction amount KRfi of the driven wheel Wfi computed under the situation of steady travelling on the down slope road with only the engine brake has a possibility of detecting the wheel speed of the driven wheel Wfi detected using the same lower than the actual wheel speed.

Thus, the wheel speed correction amount KSfi, KSri or the wheel diameter correction amount KRfi, KRri computed while travelling on the slope road has a possibility the accuracy is lowered, in which case, when the wheel speed is detected using such wheel speed correction amount KSfi, KSri or the wheel diameter correction amount KRfi, KRri, the braking/driving force control cannot be executed at high accuracy, and the accuracy of the vehicle control may lower. This is significant in a transport vehicle in which the increasing/reducing width of the carrying capacity of the baggage is large.

Thus, when performing the computation under the travelling situation in which the computation accuracy of the wheel speed correction amount KSfi, KSri or the wheel diameter correction amount KRfi, KRri lowers, the braking/driving force control device of the present embodiment performs the correction of the wheel speed correction amount KSfi, KSri or the wheel diameter correction amount KRfi, KRri to compensate for the lowering of the computation accuracy. The travelling situation in which the computation accuracy of the wheel speed correction amount KSfi, KSri, and the like lowers corresponds to when steady travelling on the slope road with the baggage of the baggage compartment reduced, as described above, for example.

Specifically, the wheel speed correcting unit performs the computation of a correction value CS of the wheel speed correction amount KSfi, KSri or a correction value CR of the wheel diameter correction amount KRfi, KRri. The correction value CS or the correction value CR are values corresponding to the gradient of the slope road when the cause of lowering in the computation accuracy of the wheel speed correction amount KSfi, KSri, and the like is in the travelling on the slope road.

One example of the computation process will be described based on the flowchart of FIG. 5.

The electronic control unit 1 determines whether or not the own vehicle is travelling on the slope road (up slope road or down slope road). Whether or not the own vehicle is travelling on the slope road is determined by determining whether or not an absolute value of a difference of an estimated vehicle body acceleration/deceleration estimated from the vehicle body speed information and a detected vehicle body acceleration/deceleration detected with a vehicle body front-back acceleration sensor 34 is larger than a predetermined value α, and whether or not a state in which the absolute value is larger than the predetermined value α is continued for a predetermined time. The vehicle body front-back acceleration sensor 34 in the illustration outputs a positive value when steady travelling on the up slope road or when the vehicle is stopped, and outputs a negative value when steady travelling on the down slope road or when the vehicle is stopped.

Therefore, the electronic control unit 1 first determines whether or not the absolute value of the difference of an estimated vehicle body acceleration/deceleration G0 and a detected vehicle body acceleration/deceleration G1 is larger than a predetermined value α (>0) (step ST1).

In step ST1, the vehicle body speed is computed based only on the wheel speed of the driven wheel, and the estimated vehicle body acceleration/deceleration (differential value of the vehicle body speed) G0 is obtained based on the vehicle body speed. When computing the vehicle body speed using the GPS, the estimated vehicle body acceleration/deceleration G0 may be computed based on such vehicle body speed or the estimated vehicle body acceleration/deceleration G0 may be computed based on the vehicle body speed obtained only from the wheel speed of the driven wheel as described above.

The predetermined value α of step ST1 may be set to an absolute value of the detected vehicle body acceleration/deceleration G1 detected with the vehicle body front-back acceleration sensor 34 while steady travelling on the slope road, for example. While steady travelling on the slope road, the estimated vehicle body acceleration/deceleration G0 becomes zero or substantially zero, and the detected vehicle body acceleration/deceleration G1 in the front and back direction of the vehicle corresponding to the gradient of the slope road is detected by the vehicle body front-back acceleration sensor 34. Even when acceleration travelling or deceleration travelling on the slope road, the estimated vehicle body acceleration/deceleration G0 becomes a value corresponding to the acceleration/deceleration travelling and a sum of the vehicle body acceleration/deceleration corresponding to the acceleration/deceleration travelling and the vehicle body acceleration/deceleration corresponding to the gradient of the slope road is detected by the vehicle body front-back acceleration sensor 34.

The predetermined value α may be set to a value the flat road and the slope road can be distinguished. However, in a case of a slope road having a very small gradient, each wheel Wfi, Wri is assumed to show a movement substantially the same as on the flat road. Therefore, the predetermined value α is set to the absolute value of the detected vehicle body acceleration/deceleration G1 of when travelling on the slope road having a minimum gradient in which the computation accuracy of the wheel speed correction amount KSfi, KSri, and the like lowers, for example. The minimum gradient varies according to the vehicle speed, the road surface friction coefficient, and the like even with respect to the same vehicle. Thus, the predetermined value α may be a variable value corresponding to the vehicle speed, the road surface friction coefficient, and the like.

As described above, in the illustrated example, whether or not a state for determining as the slope road (state in which the absolute value of the difference of the estimated vehicle body acceleration/deceleration G0 and the detected vehicle body acceleration/deceleration G1 is larger than the predetermined value α) is continued for a predetermined time is determined. Thus, when the absolute value of the difference of the estimated vehicle body acceleration/deceleration G0 and the detected vehicle body acceleration/deceleration G1 is larger than the predetermined value α, the electronic control unit 1 determines whether or not a predetermined time elapses in such state (step ST2). This determination is made to exclude errors such as noise, and the like in the wheel rotation angle sensor 31fi of the driven wheel Wfi and the vehicle body front-back acceleration sensor 34. Therefore, the predetermined time is determined based on the computation cycle of the electronic control unit 1, the detection cycles of the wheel rotation angle sensor 31fi and the vehicle body front-back acceleration sensor 34, and the like. For example, the predetermined time is to be set in accordance with a plurality of computation cycles or a plurality of detection cycles to exclude errors such as a temporary noise.

In the illustration, when the absolute value of the difference of the estimated vehicle body acceleration/deceleration G0 and the detected vehicle body acceleration/deceleration G1 is larger than the predetermined value α and such state is continued for a predetermined time through steps ST1, ST2, (Yes in ST1→Yes in ST2), positive determination of travelling on the slope road that requires the correction of the wheel speed correction amount KSfi, KSri or the wheel diameter correction amount KRfi, KRri is made, and the process proceeds to step ST3. When the absolute value of the difference of the estimated vehicle body acceleration/deceleration G0 and the detected vehicle body acceleration/deceleration G1 is larger than the predetermined value α but such state is not continued for a predetermined time (Yes in ST1→No in ST2→No in ST1), or when the absolute value is not larger than the predetermined value α in step ST1 (No in ST1) through steps ST1, ST2, negative determination of not travelling on the slope road that requires the correction of the wheel speed correction amount KSfi, KSri or the wheel diameter correction amount KRfi, KRri is made, and the process returns to step ST1.

When determining that the predetermined time elapses in step ST2, the electronic control unit 1 computes the correction value of the correction amount (step ST3). When using the wheel speed correction amounts KSfi, KSri for the wheel speed correction, the wheel speed correcting unit determines that the road is the slope road that requires the correction of the wheel speed correction amounts KSfi, KSri, and computes the correction value CS. When using the wheel diameter correction amounts KRfi, KRri for the wheel speed correction, the wheel speed correcting unit determines that the road is the slope road that requires the correction of the wheel diameter correction amounts KRfi, KRri, and computes the correction value CR.

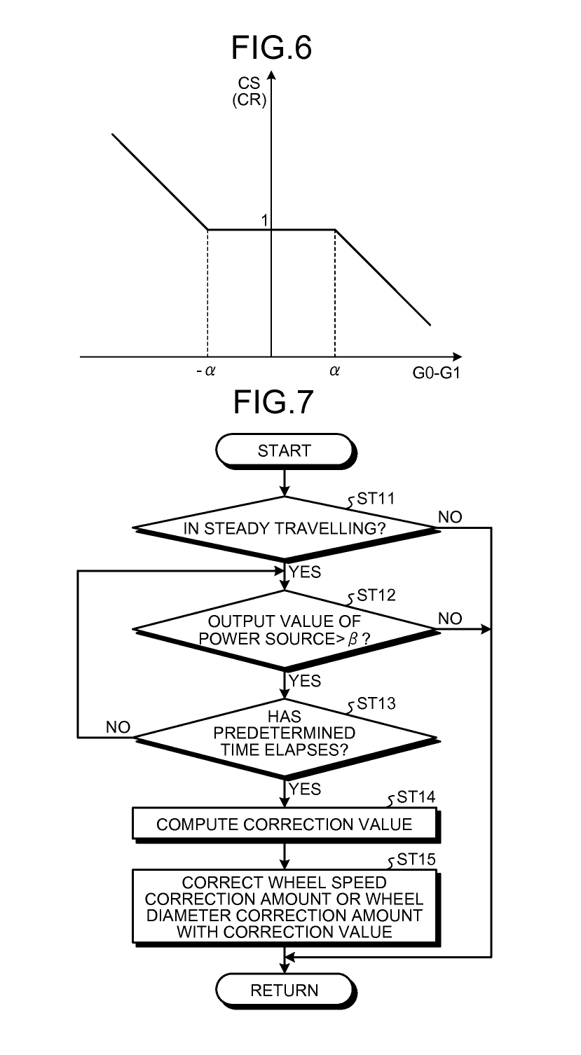

The illustrated correction value CS (>0) or the correction value CR (>0) is assumed to be divided or multiplied with respect to the wheel speed correction amount KSfi, KSri or the wheel diameter correction amount KRfi, KRri. In the case of the up slope road (G0-G1<-α), the correction in a direction of raising the wheel speed is necessary in the drive wheel Wri and the correction in a direction of lowering the wheel speed is necessary in the driven wheel Wfi. Thus, in the case of the up slope road (G0-G1<-α), the correction value CS or the correction value CR are values larger than one the greater the gradient, as illustrated in FIG. 6. In the case of the down slope road (α<G0-G1), the correction in a direction of lowering the wheel speed is necessary in the drive wheel Wri, and the correction in a direction of raising the wheel speed is necessary in the driven wheel Wfi. Thus, in the case of the down slope road (α<G0-G1), the correction value CS or the correction value CR are values smaller than one the greater the gradient, as illustrated in FIG. 6.

The electronic control unit 1 performs the correction of the correction amount using the correction value (step ST4). When using the wheel speed correction amount KSfi, KSri for the wheel speed correction, the wheel speed correcting unit divides the wheel speed correction amount KSfi of the driven wheel Wfi by the correction value CS (KSfi←KSfi/CS) and multiplies the correction value CS to the wheel speed correction amount KSri of the drive wheel Wri (KSri←KSri*CS). Furthermore, when using the wheel diameter correction amount KRfi, KRri for the wheel speed correction, the wheel speed correcting unit divides the wheel diameter correction amount KRfi of the driven wheel Wfi by the correction value CR (KRfi←KRfi/CR) and multiplies the correction value CR to the wheel diameter correction amount KRri of the drive wheel Wri (KRri←KRri*CR).

When the absolute value of the difference of the estimated vehicle body acceleration/deceleration G0 and the detected vehicle body acceleration/deceleration G1 is smaller than or equal to the predetermined value α, the correction of the wheel speed correction amount KSfi, KSri or the wheel diameter correction amount KRfi, KRri is not required. Thus, the correction value CS or the correction value CR becomes “1” when “−α≦G0-G1≦α”, as illustrated in FIG. 6.

Therefore, the braking/driving force control device can correct the shift of the wheel speed correction amount KSfi, KSri or the wheel diameter correction amount KRfi, KRri, whereby the correction accuracy of the correction control of the wheel speed or the wheel diameter using the wheel speed correction amount KSfi, KSri or the wheel diameter correction amount KRfi, KRri can be enhanced, and the detection accuracy of the detected wheel speed can be enhanced. Therefore, the braking/driving force control device can prevent the setting of the request braking force or the request driving force based on the erroneous wheel speed, so that a highly accurate braking/driving force control can be performed. The braking/driving force control device can perform the highly accurate braking/driving force control even in the vehicle control and can avoid the intervention of the unnecessary vehicle control, the intervention of excessive vehicle control, and the like, whereby the accuracy of the vehicle control can be enhanced. Such useful effects are more significantly obtained in the transport vehicle such as a truck in which the increase/reduction of the carrying capacity of the baggage is large.

In the EBD control, for example, the shift of the target braking force distribution of each wheel Wfl, Wfr, Wrl, Wrr based on the erroneous wheel speed can be avoided, and the performance of the unbalanced braking force control is avoided at each wheel Wfl, Wfr, Wrl, Wrr involved in the shift. Thus, the braking/driving force control device can prevent the change in the vehicle behavior involved in the change in the useless yaw moment.

In the ABS control, for example, an event in which determination is made as not being in the lock tendency although the wheels Wfl, Wfr, Wrl, Wrr are actually showing the lock tendency, or an event in which determination is made as being in the lock tendency although the wheels Wfl, Wfr, Wrl, Wrr are actually not showing the lock tendency based on the erroneous wheel speed can be avoided. Thus, the braking/driving force control device can achieve stabilization of the vehicle behavior by intervening the ABS control when necessary, and can reduce the possibility of the distance to stopping from becoming unnecessarily long by not intervening the ABS control when unnecessary.

In the TRC control, for example, an event in which determination is made that idle running is not being performed although the drive wheel is actually idle running or an event in which determination is made that idle running is being performed although the drive wheel is not actually idle running based on the erroneous wheel speed can be avoided. Thus, the braking/driving force control device can achieve stabilization of the vehicle behavior by intervening the TRC control when necessary, and can avoid lack of acceleration due to the useless driving force reduction by not intervening the TRC control when unnecessary.

In the VSC control, for example, the setting of the request braking/driving force with deficiency and excess of the control target wheel based on the erroneous wheel speed can be avoided. Thus, the braking/driving force control device can prevent the change in the vehicle behavior involved in the change in the useless yaw moment.

The wheel speed correcting unit performs the computation of the wheel speed correction amount KSfi, KSri or the wheel diameter correction amount KRfi, KRri at the time of steady travelling. Thus, in the illustration of FIG. 5, whether or not the own vehicle is steady travelling may be determined before the determination of step ST1. In this determination, for example, determination is made as steady travelling when travelling at a constant speed and when the steering wheel Wfi is not turned. Whether or not travelling at a constant speed may be determined based on the estimated vehicle body acceleration/deceleration G0 of step ST1, for example, and determination is made as travelling at a constant speed when the estimated vehicle body acceleration/deceleration G0 is zero or substantially zero. Whether or not the steering wheel Wfi is turned merely needs to be determined based on the steering angle of the steering wheel (not illustrated), and determination is made as travelling straight when the steering angle is zero or substantially zero.

When the own vehicle is not steady traveling, the electronic control unit 1 does not correspond to the computation condition of the wheel speed correction amount KSfi, KSri or the wheel diameter correction amount KRfi, KRri, and hence a series of computation processes of FIG. 5 is once terminated. The electronic control unit 1 proceeds to step ST1 when the own vehicle is steady travelling.

[First Modification]

In the embodiment described above, the difference of the estimated vehicle body acceleration/deceleration G0 estimated from the vehicle body speed information and the detected vehicle body acceleration/deceleration G1 detected with the vehicle body front-back acceleration sensor 34 is used to perform the determination on whether or not travelling on the slope road that requires the correction of the wheel speed correction amount KSfi, KSri or the wheel diameter correction amount KRfi, KRri. Such determination may be performed in the following manner.

For example, as illustrated in the flowchart of FIG. 7, the electronic control unit 1 determines whether or not the own vehicle is steady travelling (step ST11). This determination is performed in a manner similar to the above illustration.

When the own vehicle is not steady travelling, the electronic control unit 1 once terminates the computation process. When the own vehicle is steady travelling, the electronic control unit 1 determines whether or not the own vehicle is travelling on the up slope road based on the output value of the power source 10.

As previously described above, the driving force that resists the respective forces by the road surface resistance and the air resistance needs to be output by the power source 10 on the flat road. On the up slope road, the driving force that resists the respective forces by the road surface resistance, the air resistance, and the gravity needs to be output by the power source 10. On the down slope road, the driving force that resists the force obtained by subtracting the force by the gravity from the respective forces by the road surface resistance and the air resistance needs to be output by the power source 10. Therefore, when travelling at a constant speed on the up slope road, the power source 10 outputs a larger driving force compared to when travelling at a constant speed on the flat road or the down slope road.

Whether or not the output value of the power source 10 is larger than a predetermined value β and whether or not a state in which the output value is larger than the predetermined value β is continued for a predetermined time are performed to determine whether or not the own vehicle is travelling on the up slope road. Therefore, the electronic control unit 1 first determines whether or not the output value of the power source 10 is larger than the predetermined value β (step ST12). The predetermined value β is determined based on an output difference of the power source 10 in the flat road and the up slope road, for example. When the minimum gradient of the up slope road described above is determined, the output difference of the power source 10 of when travelling at a constant speed on the up slope road having the minimum gradient and when travelling at a constant speed on the flat road may be defined as the predetermined value β.

The output value of the power source 10 at the time of the determination is calculated from an operation amount of an accelerator pedal 40, a throttle opening, and the like. Therefore, step ST12 may be replaced with a comparison of the operation amount of the accelerator pedal 40 and a predetermined value β1 (operation amount of the accelerator pedal 40 corresponding to the predetermined value β) or a comparison of the throttle opening and a predetermined value β2 (throttle opening corresponding to the predetermined value β). The operation amount of the accelerator pedal 40 is an accelerator opening, a stroke amount of the accelerator pedal 40, and the like, and is detected by a pedal opening sensor 41. The throttle opening is detected by a throttle opening sensor 45.

As described above, in the illustration, whether or not a state that can be determined as the up slope road (state in which the output value of the power source 10 is larger than the predetermined value β, a state in which the operation amount of the accelerator pedal 40 is larger than the predetermined value β1, a state in which the throttle opening is larger than the predetermined value β2) is continued for a predetermined time is considered. Thus, when the output value of the power source 10 is larger than the predetermined value β (the operation amount of the accelerator pedal 40 is larger than the predetermined value β1, or the throttle opening is larger than the predetermined value β2), the electronic control unit 1 determines whether a predetermined time elapses in such state (step ST13). This determination is performed to exclude the temporary increase in the output of the power source 10 such as passing acceleration. Therefore, the predetermined time is set to a length longer than such temporary increasing time of the output of the power source 10, and with which determination can be made as travelling at a constant speed on the up slope road.

In the illustration, when the output value of the power source 10 is larger than the predetermined value β (the operation amount of the accelerator pedal 40 is larger than the predetermined value β1, or the throttle opening is larger than the predetermined value β2) and such state is continued for a predetermined time through steps ST12, ST13 (Yes in ST12→Yes in ST13), positive determination of travelling on the up slope road that requires the correction of the wheel speed correction amount KSfi, KSri or the wheel diameter correction amount KRfi, KRri is made, and the process proceeds to step ST14. On the contrary, in the illustration, when the output value of the power source 10 is larger than the predetermined value β (the operation amount of the accelerator pedal 40 is larger than the predetermined value β1, or the throttle opening is larger than the predetermined value β2) but such state is not continued for a predetermined time (Yes in ST12→No in ST13→No in ST12), or when the output value of the power source 10 (operation amount of the accelerator pedal 40, or the throttle opening) is not larger than the predetermined value β (β1, or β2) (No in ST12) through steps ST12, ST13, negative determination of not travelling on the up slope road is made, and the process returns to step ST11.

When determining that the predetermined time elapses in step ST13, the electronic control unit 1 computes a correction value of the correction amount (step ST14). When using the wheel speed correction amount KSfi, KSri for the wheel speed correction, the wheel speed correcting unit determines as the up slope road that requires the correction of the wheel speed correction amount KSfi, KSri, and computes the correction value CS. When using the wheel diameter correction amount KRfi, KRri for the wheel speed correction, the wheel speed correcting unit determines as the up slope road that requires the correction of the wheel diameter correction amount KRfi, KRri, and computes the correction value CR.

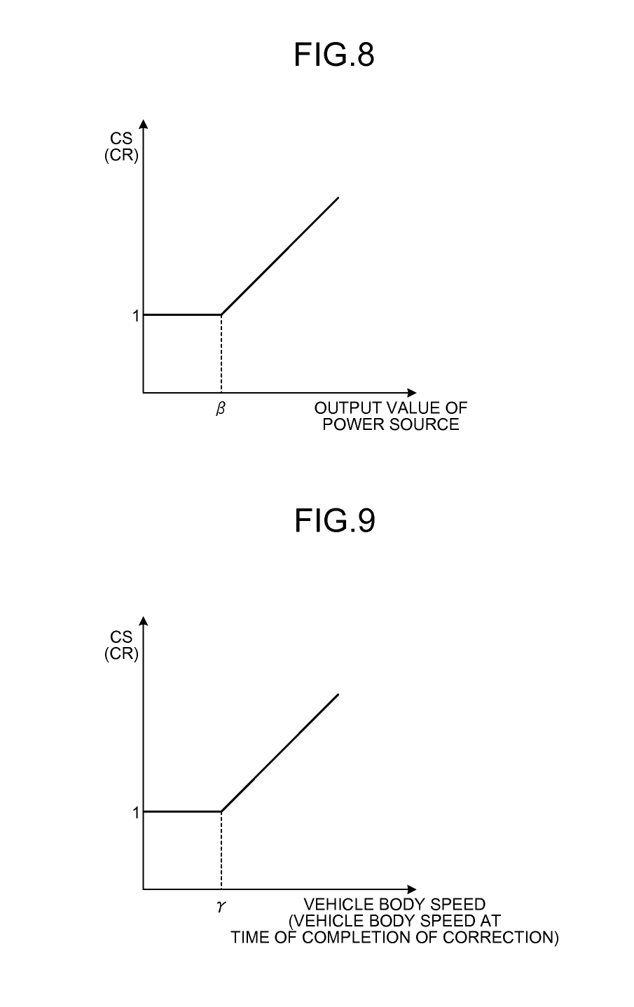

The illustrated correction value CS (>0) or the correction value CR (>0) is divided or multiplied with respect to the wheel speed correction amount KSfi, KSri or the wheel diameter correction amount KRfi, KRri. When the output value of the power source 10 is larger than the predetermined value β, this indicates travelling on the up slope road, and thus the correction in the direction of raising the wheel speed is required at the drive wheel Wri and the correction in the direction of lowering the wheel speed is required at the driven wheel Wfi. Thus, the correction value CS or the correction value CR becomes a value larger than one the greater the gradient when the output value of the power source 10 is larger than the predetermined value β, as illustrated in FIG. 8.

Similar to step ST4, the electronic control unit 1 corrects the correction amount using the correction value (step ST15).

When the output value of the power source 10 is not larger than the predetermined value β, the correction of the wheel speed correction amount KSfi, KSri or the wheel diameter correction amount KRfi, KRri is not required. Thus, the correction value CS or the correction value CR in this case become “1”, as illustrated in FIG. 8.

Therefore, the braking/driving force control device has effects similar to the embodiment since the shift of the wheel speed correction amount KSfi, KSri or the wheel diameter correction amount KRfi, KRri can be corrected.

[Second Modification]

The wind pressure received by the vehicle body increases with increase in the vehicle body speed. When the computation of the wheel speed correction amount KSfi, KSri or the wheel diameter correction amount KRfi, KRri is performed when the wind pressure is high, shift may occur in the wheel speed correction amount KSfi, KSri, and the like. In particular, when the baggage of the baggage compartment is reduced and the ground load of the drive wheel Wri is small, shift easily occurs in the computation value of the wheel speed correction amount KSfi, KSri, and the like.

In the present modification, when the vehicle body speed is larger than a predetermined value γ, determination is made that a shift occurred in the computation value of the wheel speed correction amount KSfi, KSri, and the like, and the wheel speed correction amount KSfi, KSri, and the like are corrected. A minimum value of the vehicle body speed that may cause the shift in the computation value of the wheel speed correction amount KSfi, KSri, and the like is used for the predetermined value γ.

In this case as well, the wheel speed correcting unit performs the computation of the correction value CS of the wheel speed correction amount KSfi, KSri or the correction value CR of the wheel diameter correction amount KRfi, KRri, and corrects the wheel speed correction amount KSfi, KSri or the wheel diameter correction amount KRfi, KRri using the correction value CS or the correction value CR. For example, when steady travelling at the vehicle body speed greater than the predetermined value γ, the slip ratio of the drive wheel Wri increases by the influence of the wind pressure. Therefore, the correction in the direction of raising the wheel speed is necessary in the drive wheel Wri, and the correction in the direction of lowering the wheel speed is necessary in the driven wheel Wfi.

In light of the above points, the correction value CS (>0) or the correction value CR (>0) is made greater than one as the vehicle body speed becomes higher than the predetermined value γ (FIG. 9), and the correction value CS or the correction value CR is multiplied with respect to the wheel speed correction amount KSri or the wheel diameter correction amount KRri of the drive wheel Wri and divided with respect to the wheel speed correction amount KSfi or the wheel diameter correction amount KRfi of the driven wheel Wfi. Thus, the braking/driving force control device can enhance the correction accuracy of the correction control of the wheel speed or the wheel diameter using the wheel speed correction amount KSfi, KSri or the wheel diameter correction amount KRfi, KRri of after the correction, and can enhance the detection accuracy of the detected wheel speed. Therefore, the braking/driving force control device can prevent the setting of the request braking force or the request driving force based on the erroneous wheel speed, and can perform a highly accurate braking/driving force control. Furthermore, the braking/driving force control device can perform a highly accurate braking/driving force control even in the vehicle control, and can avoid the intervention of the unnecessary vehicle control, the intervention of the excessive vehicle control, and the like, whereby the accuracy of the vehicle control can be enhanced. Such useful effects can be more significantly obtained in a transport vehicle such as a truck in which the increase/reduction of the carrying capacity of the baggage is large.

When the vehicle body speed is smaller than or equal to the predetermined value γ, the correction of the wheel speed correction amount KSfi, KSri or the wheel diameter correction amount KRfi, KRri is not required. Thus, the correction value CS or the correction value CR in this case becomes “1”, as illustrated in FIG. 9.

The correction of the wheel speed correction amount KSfi, KSri or the wheel diameter correction amount KRfi, KRri in the modification may be performed on the wheel speed correction amount KSfi, KSri or the wheel diameter correction amount KRfi, KRri of after the correction in the embodiment or the first modification, described above. When the wheel speed correction amount KSfi, KSri, and the like are corrected through a method of the embodiment or the first modification when steady travelling at the vehicle body speed greater than the predetermined value γ, the wheel speed correction amount KSri or the wheel diameter correction amount KRri of the drive wheel Wri of after the correction may detect the wheel speed of the drive wheel Wri detected using the same lower than the actual speed since the influence of the wind pressure is not taken into consideration. The wheel speed correction amount KSfi or the wheel diameter correction amount KRfi of the driven wheel Wfi similarly corrected under the travelling situation may detect the wheel speed of the driven wheel Wfi detected using the same higher than the actual speed since the influence of the wind pressure is not taken into consideration.

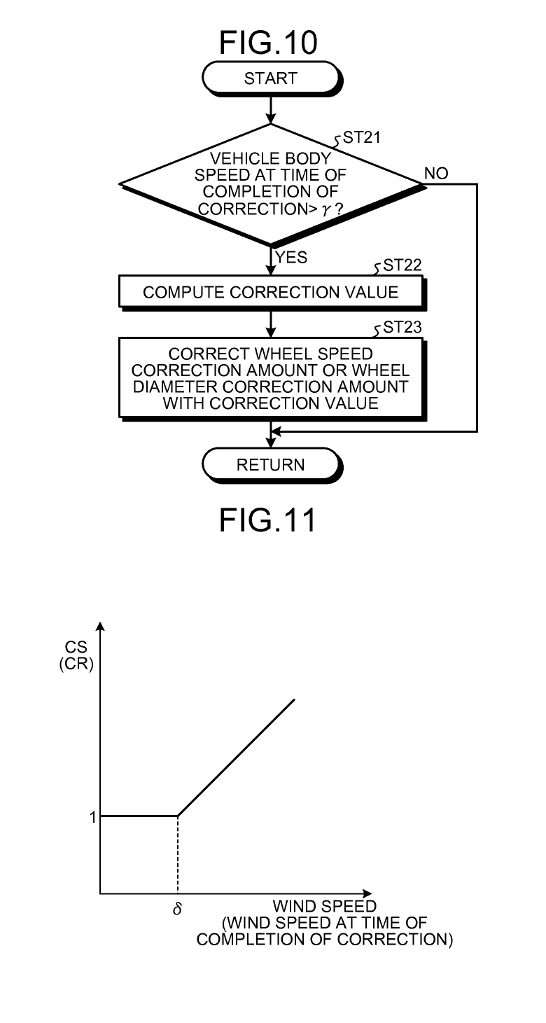

For example, the electronic control unit 1 performs the correction of the wheel speed correction amount KSfi, KSri or the wheel diameter correction amount KRfi, KRri in the embodiment or the first modification described above, and then obtains the vehicle body speed at the completion of the correction to determine whether or not the vehicle body speed is greater than the predetermined value γ, as illustrated in the flowchart of FIG. 10 (step ST21).

When the vehicle body speed is not greater than the predetermined value γ, the electronic control unit 1 determines that the shift of the wheel speed correction amount KSfi, KSri or the wheel diameter correction amount KRfi, KRri of after the correction in the embodiment or the first modification is resolved, and once terminates the present computation process.

When the vehicle body speed is greater than the predetermined value γ, the electronic control unit 1 determines that the wheel speed correction amount KSfi, KSri or the wheel diameter correction amount KRfi, KRri of after the correction are shifted by the influence of the wind pressure. Thus, the electronic control unit 1 in this case computes a further correction value with respect to the correction amount of after the correction (step ST22). When using the wheel speed correction amount KSfi, KSri for the wheel speed correction, the wheel speed correcting unit computes the correction value CS of the wheel speed correction amount KSfi, KSri. When using the wheel diameter correction amount KRfi, KRri for the wheel speed correction, the wheel speed correcting unit computes the correction value CR of the wheel diameter correction amount KRfi, KRri.

The electronic control unit 1 performs a further correction of the correction amount corrected in the embodiment or the first modification using the correction value (step ST23). When using the wheel speed correction amount KSfi, KSri for the wheel speed correction, the wheel speed correcting unit divides the wheel speed correction amount KSfi of the driven wheel Wfi by the correction value CS (KSfi←KSfi/CS), and multiplies the correction value CS to the wheel speed correction amount KSri of the drive wheel Wri (KSri←KSri*CS). When using the wheel diameter correction amount KRfi, KRri for the wheel speed correction, the wheel speed correcting unit divides the wheel diameter correction amount KRfi of the driven wheel Wfi by the correction value CR (KRfi←KRfi/CR), and multiplies the correction value CR to the wheel diameter correction amount KRri of the drive wheel Wri (KRri←KRri*CR).

Therefore, the braking/driving force control device can enhance the correction accuracy of the shift of the wheel speed correction amount KSfi, KSri or the wheel diameter correction amount KRfi, KRri with respect to the embodiment or the first modification by taking into consideration the influence of the wind pressure corresponding to the vehicle body speed. The braking/driving force control device thus can further enhance the correction accuracy of the correction control of the wheel speed or the wheel diameter using the wheel speed correction amount KSfi, KSri or the wheel diameter correction amount KRfi, KRri with respect to the embodiment and the first modification, and can further enhance the detection accuracy of the detected wheel speed. Therefore, the braking/driving force control device can more effectively prevent the setting of the request braking force or the request driving force based on the erroneous wheel speed with respect to the embodiment and the first modification, and the braking/driving force control of higher accuracy can be performed. Moreover, the braking/driving force control device can perform the braking/driving force control of higher accuracy in the vehicle control and avoid the intervention of the unnecessary vehicle control, the intervention of the excessive vehicle control, and the like with respect to the embodiment and the first modification, whereby the accuracy of the vehicle control can be further enhanced. Such useful effects are more significantly obtained in a transport vehicle such as a truck in which the increase/reduction of the carrying capacity of the baggage is large.

[Third Modification]

When receiving an opposing wind while travelling, the wind pressure received by the vehicle body increases. Thus, when the computation of the wheel speed correction amount KSfi, KSri or the wheel diameter correction amount KRfi, KRri is performed while receiving a strong opposing wind, shift may occur in the wheel speed correction amount KSfi, KSri, and the like. In particular, when the baggage of the baggage compartment is reduced and the ground load of the drive wheel Wri is small, shift easily occurs in the computation value of the wheel speed correction amount KSfi, KSri, and the like.

In the present modification, when the wind speed is larger than a predetermined value δ, determination is made that shift occurred in the computation value of the wheel speed correction amount KSfi, KSri, and the like, and the correction of the wheel speed correction amount KSfi, KSri, and the like is performed. A minimum value of the wind speed that may cause shift in the computation value of the wheel speed correction amount KSfi, KSri, and the like may be used for the predetermined value δ. The wind speed referred to herein is the speed of the wind the travelling vehicle body receives from the front, and is mainly the wind speed of the opposing wind.

In this case as well, the wheel speed correcting unit performs the computation of the correction value CS of the wheel speed correction amount KSfi, KSri or the correction value CR of the wheel diameter correction amount KRfi, KRri, and corrects the wheel speed correction amount KSfi, KSri or the wheel diameter correction amount KRfi, KRri using the correction value CS or the correction value CR. For example, when the wind speed is larger than the predetermined value δ, the slip ratio of the drive wheel Wri increases by the influence of the wind pressure. Therefore, the correction in the direction of raising the wheel speed is necessary in the drive wheel Wri, and the correction in the direction of lowering the wheel speed is necessary in the driven wheel Wfi.

In light of the above points, the correction value CS (>0) or the correction value CR (>0) is made greater than one as the wind speed becomes higher than the predetermined value δ (FIG. 11), the correction value CS or the correction value CR is multiplied with respect to the wheel speed correction amount KSri or the wheel diameter correction amount KRri of the drive wheel Wri, and divided with respect to the wheel speed correction amount KSfi or the wheel diameter correction amount KRfi of the driven wheel Wfi. Thus, the braking/driving force control device can enhance the correction accuracy of the correction control of the wheel speed or the wheel diameter using the wheel speed correction amount KSfi, KSri or the wheel diameter correction amount KRfi, KRri of after the correction, and can enhance the detection accuracy of the detected wheel speed. Therefore, the braking/driving force control device can prevent the setting of the request braking force or the request driving force based on the erroneous wheel speed, and can perform a highly accurate braking/driving force control. Furthermore, the braking/driving force control device can perform a highly accurate braking/driving force control even in the vehicle control, and can avoid the intervention of the unnecessary vehicle control, the intervention of the excessive vehicle control, and the like, whereby the accuracy of the vehicle control can be enhanced. Such useful effects can be more significantly obtained in a transport vehicle such as a truck in which the increase/reduction of the carrying capacity of the baggage is large.

When the wind speed is smaller than or equal to the predetermined value δ, the correction of the wheel speed correction amount KSfi, KSri or the wheel diameter correction amount KRfi, KRri is not required. Thus, the correction value CS or the correction value CR in this case becomes “1”, as illustrated in FIG. 11.

The correction of the wheel speed correction amount KSfi, KSri or the wheel diameter correction amount KRfi, KRri in the modification may be performed with respect to the wheel speed correction amount KSfi, KSri or the wheel diameter correction amount KRfi, KRri of after the correction in the previously described embodiment or the first modification.

The correction of the wheel speed correction amount KSfi, KSri or the wheel diameter correction amount KRfi, KRri according to the modification may be performed with respect to the wheel speed correction amount KSfi, KSri or the wheel diameter correction amount KRfi, KRri of after the final correction in the previously described second modification. Even if the vehicle body speed is smaller than or equal to the predetermined value γ in the second modification, the computation value of the heel speed correction amount KSfi, KSri, and the like may be shifted when receiving the opposing wind. For example, the wheel speed correction amount KSri or the wheel diameter correction amount KRri of the drive wheel Wri of after the final correction according to the method of the second modification does not take into consideration the influence of the wind speed and thus may detect the wheel speed of the drive wheel Wri detected using the same lower than the actual speed. The wheel speed correction amount KSfi or the wheel diameter correction amount KRfi of the driven wheel Wfi similarly corrected under the travelling situation also does not take into consideration the influence of the wind speed and thus may detect the wheel speed of the driven wheel Wfi detected using the same higher than the actual speed.

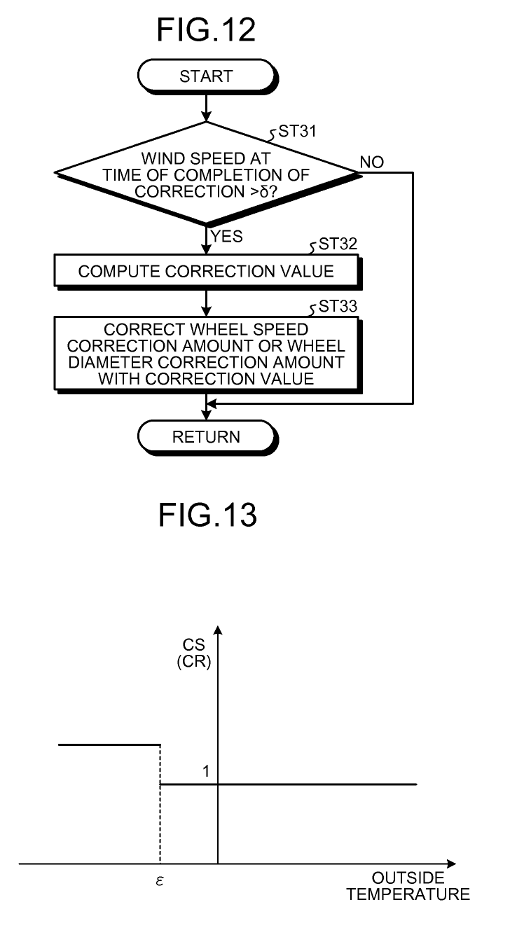

For example, after performing the final correction corresponding to the vehicle body speed of the wheel speed correction amount KSfi, KSri or the wheel diameter correction amount KRfi, KRri according to the previously described second modification, the electronic control unit 1 obtains the wind speed at the time of completion of the final correction, and determines whether or not the wind speed is higher than the predetermined value δ, as illustrated in the flowchart of FIG. 12 (step ST31). For example, the information on the wind speed may be externally received through the communication such as the road-vehicle communication, or the vehicle itself may include a wind gauge. In the latter case, the electronic control unit 1 assumes the speed obtained by subtracting the vehicle body speed from a numerical value measured with the wind gauge as the wind speed, for example.

When the wind speed is not higher than the predetermined value δ, the electronic control unit 1 determines that the shift of the wheel speed correction amount KSfi, KSri or the wheel diameter correction amount KRfi, KRri of after the final correction in the second modification is resolved, and once terminates the present computation process.

When the wind speed is higher than the predetermined value δ, the electronic control unit 1 determines that the wheel speed correction amount KSfi, KSri or the wheel diameter correction amount KRfi, KRri of after the final correction are shifted due to the influence of the wind pressure. Thus, the electronic control unit 1 in this case computes a further correction value with respect to the correction amount of after the correction (step ST32). When using the wheel speed correction amount KSfi, KSri for the wheel speed correction, the wheel speed correcting unit computes the correction value CS of the wheel speed correction amount KSfi, KSri. When using the wheel diameter correction amount KRfi, KRri for the wheel speed correction, the wheel speed correcting unit computes the correction value CR of the wheel diameter correction amount KRfi, KRri.

The electronic control unit 1 performs a further correction of the correction amount finally corrected in the second modification using the correction value (step ST33). When using the wheel speed correction amount KSfi, KSri for the wheel speed correction, the wheel speed correcting unit divides the wheel speed correction amount KSfi of the driven wheel Wfi by the correction value CS (KSfi←KSfi/CS), and multiplies the correction value CS to the wheel speed correction amount KSri of the drive wheel Wri (KSri←KSri*CS). Furthermore, when using the wheel diameter correction amount KRfi, KRri for the wheel speed correction, the wheel speed correcting unit divides the wheel diameter correction amount KRfi of the driven wheel Wfi by the correction value CR (KRfi←KRfi/CR), and multiplies the correction value CR to the wheel diameter correction amount KRri of the drive wheel Wri (KRri←KRri*CR).

Therefore, the braking/driving force control device can raise the correction accuracy of the shift of the wheel speed correction amount KSfi, KSri or the wheel diameter correction amount KRfi, KRri with respect to the second modification by also taking into consideration the influence of the wind pressure corresponding to the wind speed. The braking/driving force control device thus can further enhance the correction accuracy of the correction control of the wheel speed or the wheel diameter using the wheel speed correction amount KSfi, KSri or the wheel diameter correction amount KRfi, KRri with respect to the second modification, and can further enhance the detection accuracy of the detected wheel speed. Therefore, the braking/driving force control device can more effectively prevent the setting of the request braking force or the request driving force based on the erroneous wheel speed with respect to the second modification, and can perform the braking/driving force control of higher accuracy. Furthermore, the braking/driving force control device can perform the braking/driving force control of higher accuracy in the vehicle control, and avoid the intervention of the unnecessary vehicle control, the intervention of the excessive vehicle control, and the like with respect to the second modification, and thus can further enhance the accuracy of the vehicle control. Such useful effects are more significantly obtained in a transport vehicle such as a truck in which the increase/reduction of the carrying capacity of the baggage is large.

When correcting the wheel speed correction amount KSfi, KSri or the wheel diameter correction amount KRfi, KRri of after the correction in the second modification, the wheel speed correcting unit may perform the correction of the present modification with respect to the final wheel speed correction amount KSfi, KSri or the wheel diameter correction amount KRfi, KRri in which the correction is performed with the correction value CS or the correction value CR corresponding to the vehicle body speed as described above. However, the wheel speed correcting unit may perform the correction of the present modification with respect to the wheel speed correction amount KSfi, KSri of after the correction or the wheel diameter correction amount KRfi, KRri of after the correction of before being corrected with the correction value CS or the correction value CR corresponding to the vehicle body speed, and thereafter, perform the correction with the correction value CS or the correction value CR corresponding to the vehicle body speed with respect to the wheel speed correction amount KSfi, KSri or the wheel diameter correction amount KRfi, KRri of after the correction.

[Fourth Modification]

When the outside temperature is low, the friction coefficient of the road surface may lower by road surface freezing, snow, and the like. Thus, when the computation of the wheel speed correction amount KSfi, KSri or the wheel diameter correction amount KRfi, KRri is performed when the outside temperature is low, shift may occur in the wheel speed correction amount KSfi, KSri, and the like. In particular, the shift easily occurs in the computation value of the wheel speed correction amount KSfi, KSri, and the like when the baggage of the baggage compartment is reduced and the ground load of the drive wheel Wri is small.

Thus, in the present modification, when the outside temperature is lower than or equal to a predetermined value ε, determination is made that the computation value of the wheel speed correction amount KSfi, KSri, and the like is shifted, and the correction of the wheel speed correction amount KSfi, KSri, and the like is performed. A highest value of the outside temperature that causes shift in the computation value of the wheel speed correction amount KSfi, KSri, and the like or lowers the friction coefficient of the road surface by road surface freezing, snow, or the like may be used for the predetermined value ε.

In this case as well, the wheel speed correcting unit performs the computation of the correction value CS of the wheel speed correction amount KSfi, KSri or the correction value CR of the wheel diameter correction amount KRfi, KRri, and corrects the wheel speed correction amount KSfi, KSri or the wheel diameter correction amount KRfi, KRri using the correction value CS or the correction value CR. For example, when the outside temperature is lower than or equal to the predetermined value ε, the slip ratio of the drive wheel Wri increases by the influence of lowering of the road surface friction coefficient. Therefore, the correction in the direction of raising the wheel speed is necessary at the drive wheel Wri, and the correction in the direction of lowering the wheel speed is necessary at the driven wheel Wfi.

In light of the above points, when the outside temperature becomes lower than the predetermined value ε, and the correction value CS (>0) or the correction value CR (>0) is made greater than one (FIG. 13), the correction value CS or the correction value CR is multiplied with respect to the wheel speed correction amount KSri or the wheel diameter correction amount KRri of the drive wheel Wri, and divided with respect to the wheel speed correction amount KSfi or the wheel diameter correction amount KRfi of the driven wheel Wfi. Thus, the braking/driving force control device can enhance the correction accuracy of the correction control of the wheel speed or the wheel diameter using the wheel speed correction amount KSfi, KSri or the wheel diameter correction amount KRfi, KRri of after the correction, and can enhance the detection accuracy of the detected wheel speed. Therefore, the braking/driving force control device can prevent the setting of the request braking force or the request driving force based on the erroneous wheel speed, and can perform a highly accurate braking/driving force control. Furthermore, the braking/driving force control device can perform a highly accurate braking/driving force control even in the vehicle control, and can avoid the intervention of the unnecessary vehicle control, the intervention of the excessive vehicle control, and the like, whereby the accuracy of the vehicle control can be enhanced. Such useful effects can be more significantly obtained in a transport vehicle such as a truck in which the increase/reduction of the carrying capacity of the baggage is large.

When the outside temperature is a temperature higher than the predetermined value ε, the correction of the wheel speed correction amount KSfi, KSri or the wheel diameter correction amount KRfi, KRri is not necessary. Thus, the correction value CS or the correction value CR in this case becomes “1”, as illustrated in FIG. 13.

The correction of the wheel speed correction amount KSfi, KSri or the wheel diameter correction amount KRfi, KRri in the modification may be performed on the wheel speed correction amount KSfi, KSri or the wheel diameter correction amount KRfi, KRri of after the correction in the previously described embodiment and the first to third modifications. When the wheel speed correction amount KSfi, KSri, and the like are corrected through the methods of the embodiment and the first to third modifications when steady travelling in a state the outside temperature is lower than or equal to the predetermined value δ, the wheel speed correction amount KSri or the wheel diameter correction amount KRri of the drive wheel Wri of after the correction does not take into consideration the influence of the lowering of the road surface friction coefficient, and thus may cause detect the wheel speed of the drive wheel Wri detected using the same lower than the actual speed. The wheel speed correction amount KSfi or the wheel diameter correction amount KRfi of the driven wheel Wfi similarly corrected under the relevant travelling situation does not take into consideration the influence of the lowering of the road surface coefficient, and thus may detect the wheel speed of the driven wheel Wfi detected using the same higher than the actual speed.

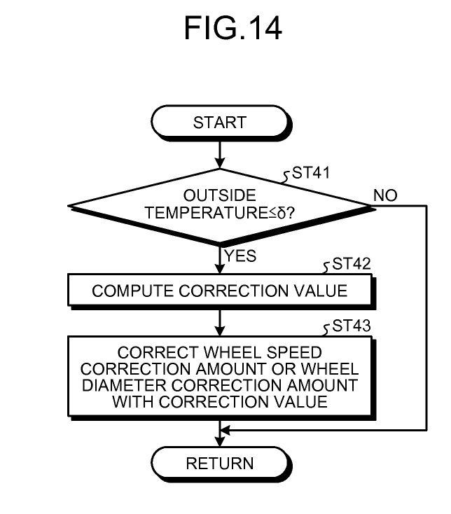

For example, after performing the correction of the wheel speed correction amount KSfi, KSri or the wheel diameter correction amount KRfi, KRri in the previously described embodiment and the first to third modifications, the electronic control unit 1 measures the outside temperature with an outside temperature sensor 46, and determines whether or not the outside temperature is lower than or equal to the predetermined value δ, as illustrated in the flowchart of FIG. 14 (step ST41). The outside temperature may be known through the communication such as the road-vehicle communication.

When the outside temperature is a temperature higher than the predetermined value δ, the electronic control unit 1 determines that the shift of the wheel speed correction amount KSfi, KSri or the wheel diameter correction amount KRfi, KRri of after the correction in the embodiment and the first to third modifications is resolved, and once terminates the present computation process.

When the outside temperature is lower than or equal to the predetermined value δ, the electronic control unit 1 determines that the wheel speed correction amount KSfi, KSri or the wheel diameter correction amount KRfi, KRri of after the correction is shifted by the influence of the lowering of the road surface friction coefficient. Thus, the electronic control unit 1 in this case computes a further correction value with respect to the correction amount of after the correction (step ST42). When using the wheel speed correction amount KSfi, KSri for the wheel speed correction, the wheel speed correcting unit computes the correction value CS of the wheel speed correction amount KSfi, KSri. When using the wheel diameter correction amount KRfi, KRri for the wheel speed correction, the wheel speed correcting unit computes the correction value CR of the wheel diameter correction amount KRfi, KRri.

The electronic control unit 1 performs further correction of the correction amount corrected in the embodiment and the first to third modifications using such correction value (step ST43). When using the wheel speed correction amount KSfi, KSri for the wheel speed correction, the wheel speed correcting unit divides the wheel speed correction amount KSfi of the driven wheel Wfi by the correction value CS (KSfi←KSfi/CS) and multiplies the correction value CS to the wheel speed correction amount KSri of the drive wheel Wri (KSri←KSri*CS). When using the wheel diameter correction amount KRfi, KRri for the wheel speed correction, the wheel speed correcting unit divides the wheel diameter correction amount KRfi of the driven wheel Wfi by the correction value CR (KRfi←KRfi/CR) and multiplies the correction value CR to the wheel diameter correction amount KRri of the drive wheel Wri (KRri←KRri*CR).

Therefore, the braking/driving force control device can raise the correction accuracy of the shift of the wheel speed correction amount KSfi, KSri or the wheel diameter correction amount KRfi, KRri with respect to the embodiment and the first to third modifications by also taking into consideration the influence of the lowering of the road surface friction coefficient involved in the lowering of the outside temperature. Thus, the braking/driving force control device can further enhance the correction accuracy of the correction control of the wheel speed or the wheel diameter using the wheel speed correction amount KSfi, KSri or the wheel diameter correction amount KRfi, KRri, and can further enhance the detection accuracy of the detected wheel speed with respect to the embodiment and the first to third modifications. Therefore, the braking/driving force control device can more effectively prevent the setting of the request braking force or the request driving force based on the erroneous wheel speed and perform the braking/driving force control of higher accuracy with respect to the embodiment and the first to third modifications. Furthermore, the braking/driving force control device can perform the braking/driving force control of higher accuracy in the vehicle control, and avoid the intervention of the unnecessary vehicle control, the intervention of the excessive vehicle control, and the like, and thus can further enhance the accuracy of the vehicle control with respect to the embodiment and the first to third modifications. Such useful effects are more significantly obtained in a transport vehicle such as a truck in which the increase/reduction of the carrying capacity of the baggage is large.

When correcting the wheel speed correction amount KSfi, KSri or the wheel diameter correction amount KRfi, KRri of after the correction in the second modification, the wheel speed correcting unit performs the correction of the present modification with respect to the final wheel speed correction amount KSfi, KSri or the wheel diameter correction amount KRfi, KRri in which the correction is performed with the correction value CS or the correction value CR corresponding to the vehicle body speed. The wheel speed correcting unit may perform the correction of the present modification with respect to the wheel speed correction amount KSfi, KSri of after the correction or the wheel diameter correction amount KRfi, KRri of after the correction of before being corrected with the correction value CS or the correction value CR corresponding to the vehicle body speed, and thereafter, perform the correction with the correction value CS or the correction value CR corresponding to the vehicle body speed with respect to the wheel speed correction amount KSfi, KSri or the wheel diameter correction amount KRfi, KRri of after the correction.

When correcting the wheel speed correction amount KSfi, KSri or the wheel diameter correction amount KRfi, KRri of after the correction in the third modification, the wheel speed correcting unit is to perform the correction of the present modification with respect to the final wheel speed correction amount KSfi, KSri or the wheel diameter correction amount KRfi, KRri in which the correction is performed with the correction value CS or the correction value CR corresponding to the wind speed. The wheel speed correcting unit may perform the correction of the present modification with respect to the wheel speed correction amount KSfi, KSri of after the correction or the wheel diameter correction amount KRfi, KRri of after the correction of before being corrected with the correction value CS or the correction value CR corresponding to the wind speed, and thereafter, perform the correction with the correction value CS or the correction value CR corresponding to the wind speed with respect to the wheel speed correction amount KSfi, KSri or the wheel diameter correction amount KRfi, KRri of after the correction. The wheel speed correction amount KSfi, KSri of after the correction or the wheel diameter correction amount KRfi, KRri of after the correction of before being corrected with the correction value CS or the correction value CR corresponding to the wind speed are the wheel speed correction amount KSfi, KSri of after the correction or the wheel diameter correction amount KRfi, KRri of after the correction of before being corrected with the correction value CS or the correction value CR corresponding to the vehicle body speed, or the wheel speed correction amount KSfi, KSri of after the correction or the wheel diameter correction amount KRfi, KRri of after the correction in which the correction is performed with the correction value CS or the correction value CR corresponding to the vehicle body speed.

An example of the rear wheel drive vehicle has been described above in the braking/driving force control device of the embodiment and the first to fourth modifications, but the respective techniques of correcting the wheel speed correction amount KSfi, KSri or the wheel diameter correction amount KRfi, KRri in the braking/driving force control devices can also be applied to the front wheel drive vehicle in a manner similar to the case of the rear wheel drive vehicle when there is a possibility shift may occur in the wheel speed correction amount KSfi, KSri or the wheel diameter correction amount KRfi, KRri.

### REFERENCE SIGNS LIST

1 ELECTRONIC CONTROL UNIT
10 POWER SOURCE
20 BRAKING DEVICE
31fl, 31fr, 31rl, 31rr WHEEL ROTATION ANGLE SENSOR
32 VEHICLE SPEED DETECTING DEVICE
33 VEHICLE BODY LATERAL ACCELERATION SENSOR
34 VEHICLE BODY FRONT-BACK ACCELERATION SENSOR
41 PEDAL OPENING SENSOR
45 THROTTLE OPENING SENSOR
46 OUTSIDE TEMPERATURE SENSOR
Wfl, Wfr, Wrl, Wrr WHEEL

1. A braking/driving force control device comprising:
a braking/driving force control unit configured to control a braking/driving force of a vehicle based on a wheel speed; and
a wheel speed correcting unit configured to compute a wheel speed correction amount for matching detected speeds of all wheels to a predetermined speed for every wheel and correct the detected wheel speed of the wheel with the wheel speed correction amount of the wheel, or compute a wheel diameter correction amount for matching detected wheel diameters of all wheels to a predetermined wheel diameter for every wheel and correct the detected wheel speed of the wheel using the wheel diameter correction amount of the wheel, wherein
the wheel speed correcting unit computes a correction value of the wheel speed correction amount or a correction value of the wheel diameter correction amount based on a difference between an estimated vehicle body acceleration/deceleration estimated from a vehicle body speed and a detected vehicle body acceleration/deceleration detected by a vehicle body front-back acceleration sensor or an output value of a power source, and corrects the computed wheel speed correction amount with the correction value of the wheel speed correction amount or corrects the computed wheel diameter correction amount with the correction value of the wheel diameter correction amount.

2. The braking/driving force control device according to claim 1, wherein
the wheel speed correcting unit executes the correction of the computed wheel speed correction amount or the correction of the computed wheel diameter correction amount while travelling on an up slope road or a down slope road.

3. The braking/driving force control device according to claim 1, wherein
the wheel speed correcting unit computes a correction value of a wheel speed correction amount or a correction value of a wheel diameter correction amount based on a vehicle body speed, and corrects the wheel speed correction amount of after the correction with the correction value of the wheel speed correction amount corresponding to the vehicle body speed, or corrects the wheel diameter correction amount of after the correction with the correction value of the wheel diameter correction amount corresponding to the vehicle body speed.

4. The braking/driving force control device according to claim 1, wherein
the wheel speed correcting unit computes a correction value of a wheel speed correction amount and a correction value of a wheel diameter correction amount based on a wind speed, and corrects the wheel speed correction amount of after the correction with the correction value of the wheel speed correction amount corresponding to the wind speed, or corrects the wheel diameter correction amount of after the correction with the correction value of the wheel diameter correction amount corresponding to the wind speed.

5. The braking/driving force control device according to claim 1, wherein
the wheel speed correcting unit computes a correction value of a wheel speed correction amount and a correction value of a wheel diameter correction amount based on an outside temperature, and corrects the wheel speed correction amount of after the correction with the correction value of the wheel speed correction amount corresponding to the outside temperature, or corrects the wheel diameter correction amount of after the correction with the correction value of the wheel diameter correction amount corresponding to the outside temperature.

6. The braking/driving force control device according to claim 2, wherein
the wheel speed correcting unit computes a correction value of a wheel speed correction amount or a correction value of a wheel diameter correction amount based on a vehicle body speed, and corrects the wheel speed correction amount of after the correction with the correction value of the wheel speed correction amount corresponding to the vehicle body speed, or corrects the wheel diameter correction amount of after the correction with the correction value of the wheel diameter correction amount corresponding to the vehicle body speed.

7. The braking/driving force control device according to claim 2, wherein
the wheel speed correcting unit computes a correction value of a wheel speed correction amount and a correction value of a wheel diameter correction amount based on a wind speed, and corrects the wheel speed correction amount of after the correction with the correction value of the wheel speed correction amount corresponding to the wind speed, or corrects the wheel diameter correction amount of after the correction with the correction value of the wheel diameter correction amount corresponding to the wind speed.

8. The braking/driving force control device according to claim 3, wherein
the wheel speed correcting unit computes a correction value of a wheel speed correction amount and a correction value of a wheel diameter correction amount based on a wind speed, and corrects the wheel speed correction amount of after the correction with the correction value of the wheel speed correction amount corresponding to the wind speed, or corrects the wheel diameter correction amount of after the correction with the correction value of the wheel diameter correction amount corresponding to the wind speed.

9. The braking/driving force control device according to claim 2, wherein
the wheel speed correcting unit computes a correction value of a wheel speed correction amount and a correction value of a wheel diameter correction amount based on an outside temperature, and corrects the wheel speed correction amount of after the correction with the correction value of the wheel speed correction amount corresponding to the outside temperature, or corrects the wheel diameter correction amount of after the correction with the correction value of the wheel diameter correction amount corresponding to the outside temperature.

10. The braking/driving force control device according to claim 3, wherein
the wheel speed correcting unit computes a correction value of a wheel speed correction amount and a correction value of a wheel diameter correction amount based on an outside temperature, and corrects the wheel speed correction amount of after the correction with the correction value of the wheel speed correction amount corresponding to the outside temperature, or corrects the wheel diameter correction amount of after the correction with the correction value of the wheel diameter correction amount corresponding to the outside temperature.
